(19) United States
(12) Patent Application Publication
(10) Pub. No.: US 2006/0165261 A1
(43) Pub. Date: Jul. 27, 2006

(54) Structure for supporting a human hand in an operating environment

(76) Inventor: Robert K. Pira, Tucson, AZ (US)

Correspondence Address: Lawrence R. Oremland, P.C., Suite C-214, 5055 E. Broadway Boulevard, Tucson, AZ, 85711, US

(21) Appl. No.: 11/041,677

(22) Filed: Jan. 24, 2005

(51) Int. Cl. G06K 9/00

(52) U.S. Cl. 382/115

(57) ABSTRACT

A new and useful apparatus and technique are provided for supporting a human hand in an operating environment, particularly a biometric identification system, in which imaging of the back of a person's hand, particularly the back of the person's palm, is used as the biometric identifier. Consistently supporting a human hand in an operating environment enables a biometric feature of the person's hand (e.g. the vein pattern of the person's hand) to be compared to a previously recorded digitized image of the person's hand, in order to identify the person. The present invention provides a three dimensional rounded support surface that is configured to receive and support a human hand, with the back side of the palm facing a predetermined portion of the operating environment (e.g. the imaging device of the scanning system). The principles of the present invention are particularly useful in providing a support surface that consistently and accurately position a person's hand in a predetermined relation to the scanning system.

### BACKGROUND

The present invention relates to structure for supporting a human hand in an operating environment, such as a biometric scanning system.

Biometric identification is based on a paradigm in which a feature of a person is scanned, recorded and used as an identifier for the person. For example, biometric identification has been based on external characteristics such as facial recognition, voice recognition, fingerprint recognition, retinal scanning, etc.

The present invention is based on the further recognition by the applicant that biometric identification of a human can also be based on vein pattern recognition, where the vein pattern in a person's hand, particularly the back side of the person's palm, can be used as the identifier. In such a biometric identification system, it is important that the person's hand be consistently and accurately placed in predetermined relation to the scanning sensor (i.e. the imaging device that receives the image data of the back side of the person's hand), so that the image data that is received will be accurate enough to allow such identification.

### SUMMARY OF THE PRESENT INVENTION

The present invention provides a new and useful apparatus and technique for use in an operating environment, particularly a biometric identification system in which imaging of the back of a person's hand, particularly the back of the person's palm, is used as the biometric identifier. Thus, a live image of the back of a person's hand can be compared to a previously recorded digitized image of the person's hand, in order to identify the person.

When used in a biometric identification system, the present invention provides a three dimensional rounded support surface that is configured to receive and support a human hand, with the back side of the palm facing a predetermined portion of the scanning system (e.g. the imaging device of the scanning system). The principles of the present invention are particularly useful in providing a support surface that consistently and accurately position a person's hand in a predetermined relation to the scanning system.

According to a preferred version of the present invention, the rounded support surface includes at least one post projecting above the rounded surface at a predetermined location, and/or a plurality of recesses, each configured to receive a finger of a human hand. The locations of the post and the recesses are configured to enable a human hand that is resting on the support surface to be consistently positioned in a predetermined relation to the scanning system, particularly the imaging component of the scanning system, irrespective of whether the hand is a right or a left hand. For example, when the scanning system is imaging the back side of the person's palm, the support is configured to consistently support the hand in a predetermined position with the back of the palm within the range of focus of the imaging component forming part of the scanning system.

Thus, with a biometric scanning system that uses a hand support according to the present invention, the imaging device can identify a human vein pattern, by imaging the back of the human hand, and using that image data to identify the human associated with that hand.

Further features of the present invention will be apparent from the following detailed description and the accompanying drawings and Exhibits.

### BRIEF DESCRIPTION OF THE DRAWINGS AND EXHIBITS

FIG. 1 is a schematic three dimensional illustration of a biometric sensing system with a support device according to the principles of the present invention;

FIG. 2 is a schematic front view of the sensing system of FIG. 1;

FIG. 3 is a schematic rear view of the sensing system of FIG. 1;

FIG. 4 is a schematic right side view of the sensing system of FIG. 1, with portions broken away;

FIG. 5 is a schematic left side view of the sensing system of FIG. 1;

FIG. 6 is a schematic top view of the sensing system of FIG. 1;

FIG. 7 is a schematic bottom view of the sensing system of FIG. 1;

FIG. 8 is a schematic three dimensional illustration of a support device according to the principles of the present invention;

FIG. 9 is a schematic front view of the support device of FIG. 8;

FIG. 10 is a schematic rear view of the support device of FIG. 8;

FIG. 11 is a schematic left side view of the support device of FIG. 8;

FIG. 12 is a schematic right side view of the support device of FIG. 8;

FIG. 13 is a schematic top view of the support device of FIG. 8; and

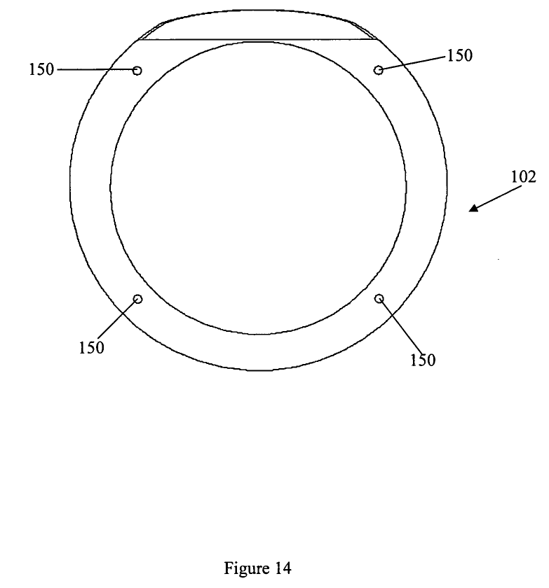

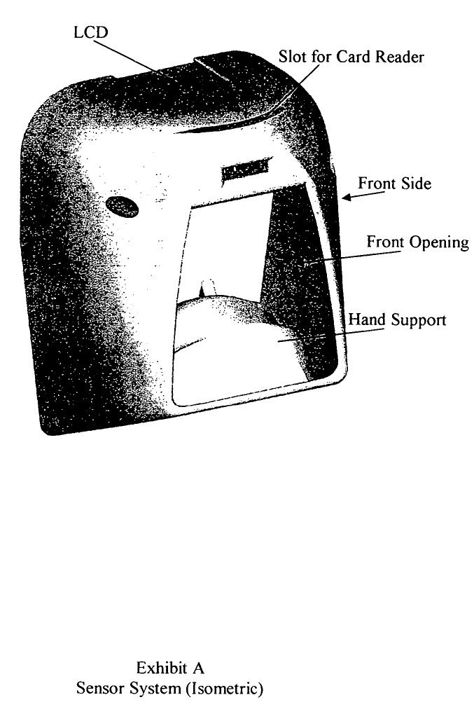

Figure is a schematic bottom view of the support device of FIG. 8.

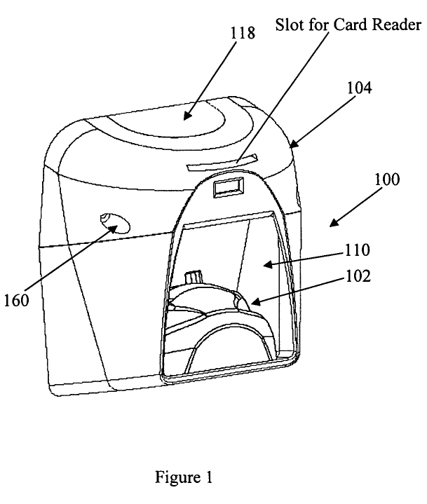

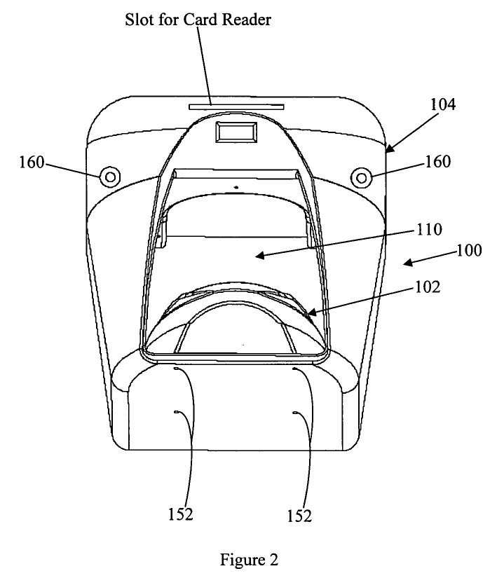

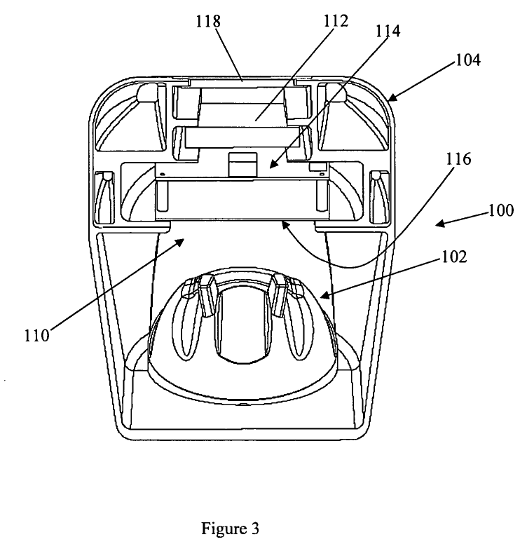

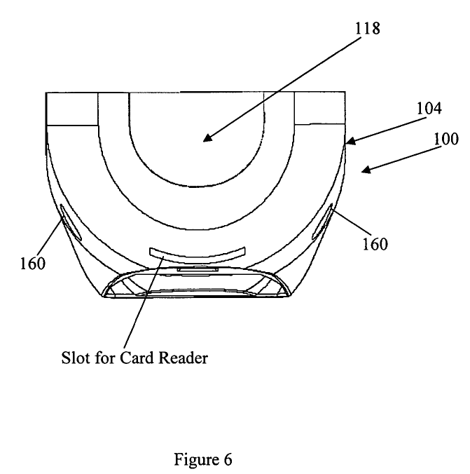

Exhibits A-B are drawings of the sensing system of FIGS. 1-7; and

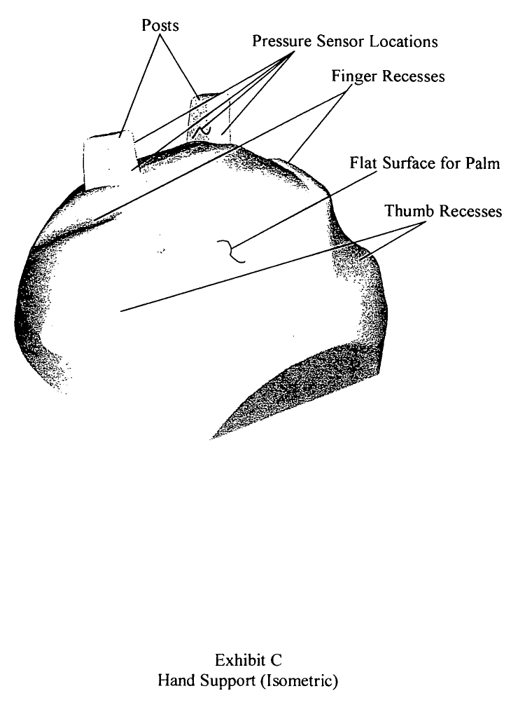

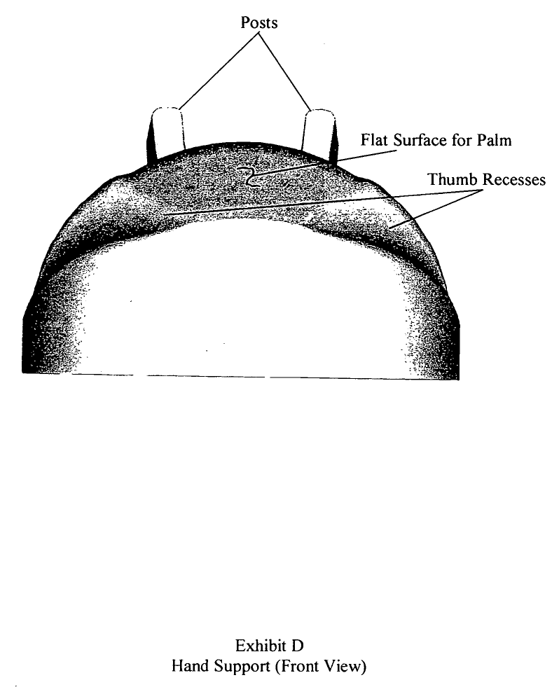

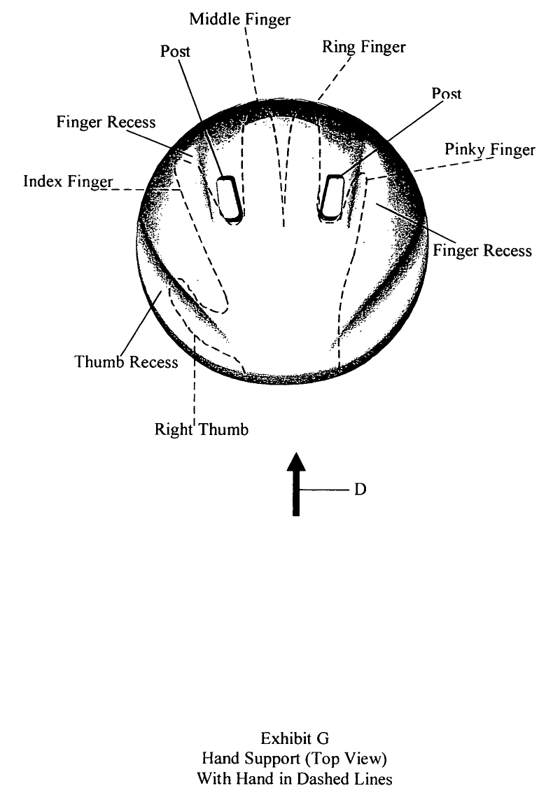

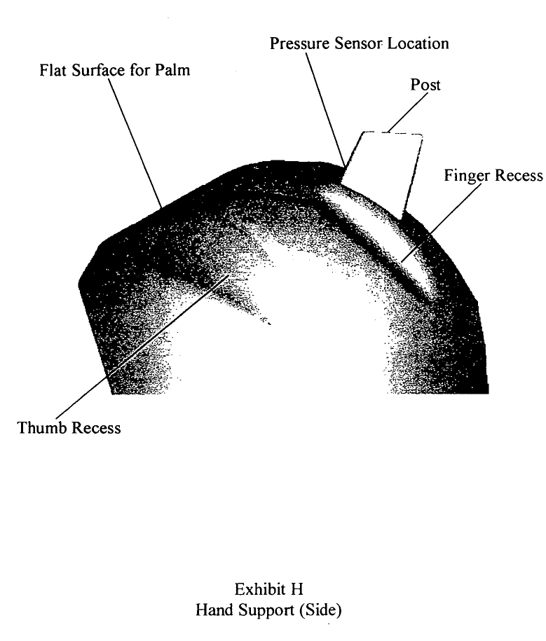

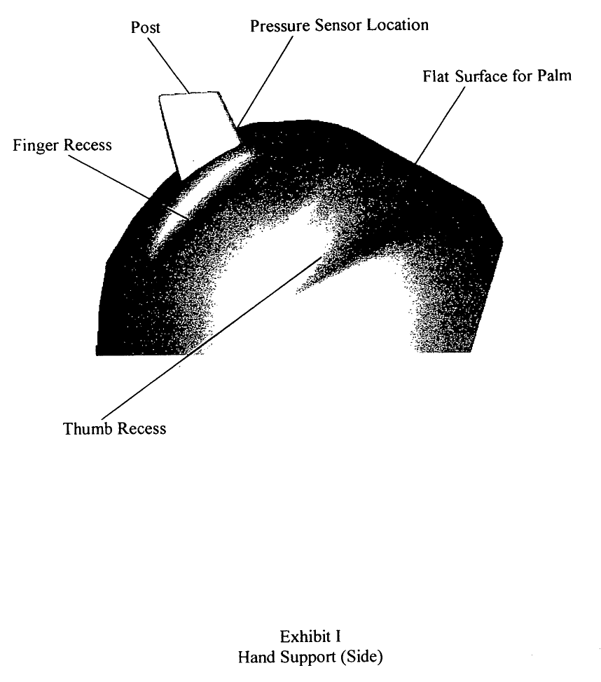

Exhibits C-I are drawings of the support device of FIGS. 8-14.

### DETAILED DESCRIPTION

As described above, the present invention provides structure for supporting a human hand in an operating environment, such as a biometric scanning system. The principles of the present invention are described below in connection with a biometric scanning system. However, from that description, the manner in which the principles of the present invention can be used to provide a support for a human hand in various types of operating environments will be apparent to those in the art.

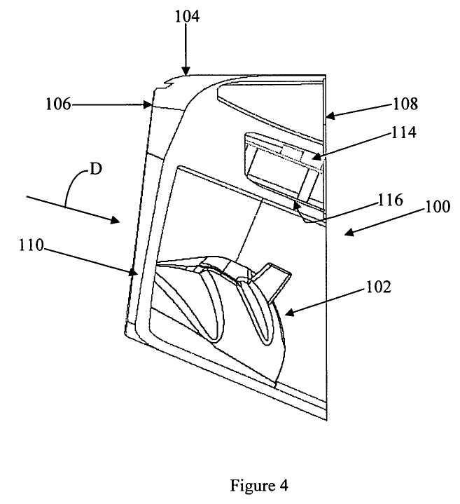

FIGS. 1-7 schematically illustrate a biometric hand scanning system 100, with a hand support 102 according to the present invention. The hand scanning system 100 includes a housing 104 with a front side 106 and a rear side 108 (FIG. 4). The housing 102 is configured to be supported on a wall with the rear side 108 against the wall, and the front side 106 away from the wall. The front side 106 includes a front opening 110 (FIGS. 1-4) through which a human hand is extended, so that the hand can be supported on the hand support 102. When a hand is supported on the hand support, the backside of the palm of the hand is facing the scanning component of the scanning system. When the backside of the palm of the hand is scanned, e.g. through use of a digital camera inside the scanner housing 104, an image of the vein pattern on the backside of the palm of the hand is obtained. The scanned digitized image is compared to a digitized image of a vein pattern obtained from data on a “smart card” the user presents to the scanner. A smart card is industry terminology describing a credit card with a microchip and antenna laminated inside. The microchip is capable of storing and emitting information through the antenna when it encounters a magnetic field. The smart card is not a part of the present invention and is merely being described as an example of a data storage device. The scanner then programmatically compares the images and outputs the result as a match or not a match. Again, the manner in which the scanner captures and compares the image and outputs the result is not a part of the present invention; and is described herein to provide the environment in which the present invention can be used, thereby to facilitate an understanding of the principles of the present invention.

Additional components of the scanning system 100 include a card reader 112, a processor board 114 that includes the camera, a protective cover lens 116 associated with the camera, and a liquid crystal display (LCD) 118 on the top of the housing. The card reader 112, processor board 114, and protective cover lens 116 carry out the overall scanning functions of the scanning system, as described above. The LDC 118 provides a visual aid in assisting a user in properly inserting the user's hand into the housing. Such features are also not part of the present invention, and are provided to further provide the environment in which the present invention is used, to facilitate an understanding of the principles of the present invention.

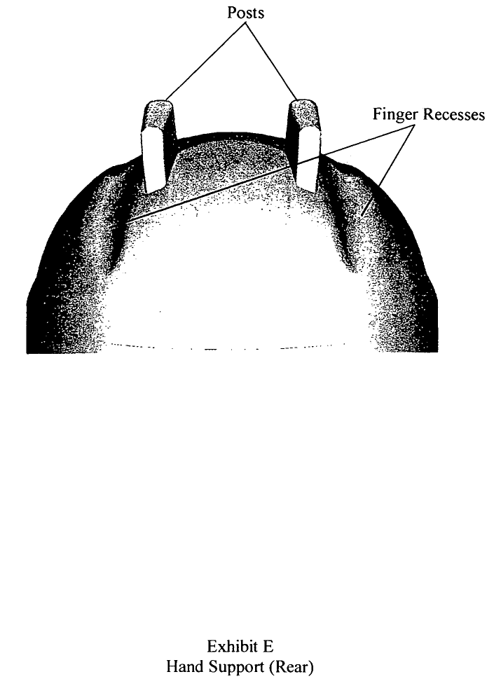

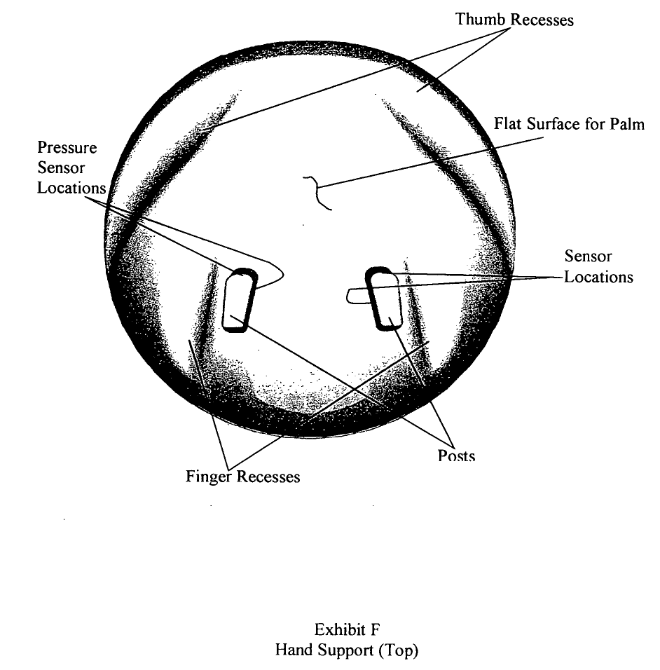

FIGS. 8-14 illustrate the configuration of a hand support 102 that is configured according to the principles of the present invention. The hand support 102 has a front side 102a and a rear side 102b (FIGS. 11, 12, 13). The front side 102a is oriented closest to the front side 106 of the housing. The rear side 102b is oriented toward the rear side 108 of the housing.

The hand support 102 has a three dimensional rounded support surface 120, which is configured to receive and support a human hand, with the hand in a rounded position and the back side of the palm facing a predetermined portion of the scanning system 100. In this application, “rounded” support surface means a surface configured such that a cross section taken through the surface will have a circular, curved or complex curved configuration (meaning a plurality of curves that may or may not have the same curvature, and which may also include one or more straight lines). Moreover, a “rounded position” for a hand means a relatively natural rounded or curved position of the palm of a hand when the hand is resting on a ball or some other rounded object.

The support surface 120 includes at least one positioning device that is configured to enable a human hand to be positioned in a substantially similar position in relation to the scanning system each time the hand is supported on the support surface. In the illustrated preferred embodiment the positioning device comprises recesses 124, 126, 128, 130 in the support surface, and a pair of spaced apart posts 132, 134 extending outward from the support surface. The recesses and posts are preferably formed in one piece with the support surface (e.g. the hand support 102, with the recesses and posts, is preferably formed as a single molded article from a synthetic resin material and it is contemplated that the hand support can also be formed from other materials).

The recesses 124, 126, 128, 130 are each configured to receive a predetermined finger of a human hand when the hand is supported on the support surface. Thus, the recesses 124, 126 are configured to receive the thumb of a human hand (the recess 124 is oriented to receive the thumb of a right hand and the recess 126 is oriented to receive the thumb of a left hand). The recesses 128, 130 are located adjacent the outsides of the posts 132, 134, and are configured to receive the index and pinkie fingers of a hand. The posts 132, 134 are spaced apart a distance such that the ring and middle fingers of a human hand can be placed between the posts, with the sides of those fingers against the inner walls 132a, 134a of the posts, and webs between the index and middle finger and between the ring finger and pinkie finger against the front walls 132b, 134b of the posts. FIG. 4 and Exhibit G schematically illustrates the direction D from which a hand is inserted into the sensing system and onto the support device 102, and Exhibit G further illustrates (in dashed lines) the position of the hand when it is resting on the support device 102. The support surface 120 also has a relatively flat surface portion 140 against which the palm of a human hand would normally rest when the hand is supported on the support surface, irrespective of whether the hand is a right or a left hand.

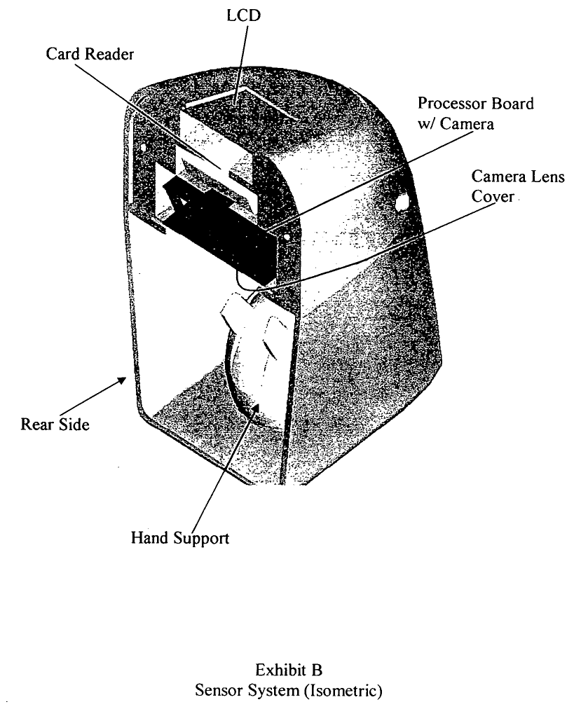

The height L of the support surface (see FIG. 9) is configured to enable the back of the palm of a hand resting on the support surface to be within the range of focus of an imaging device (e.g. the camera) forming part of the scanning system. Thus, when a hand is resting on the support surface, the back of the palm of the hand will naturally face the camera of the scanning system, so that the camera can scan the vein pattern on the backside of the person's palm.

In the use of a scanning system with a hand support device according to the present invention, the live hand should be in a repeatable position with respect to the digital camera inside the scanner housing, so that the vein pattern of the hand can be reliably scanned and compared to the image on the smart card (which would have been produced from the same hand). As should be clear from the foregoing description, a person would extend either hand into the front opening 110 in the housing 104. Irrespective of which hand is inserted the palm of the hand should rest on the substantially flat surface 140, the ring and middle fingers should be located between the posts 132, 134, the index and pinkie fingers should be located in recesses 128, 130, and the thumb of the hand will be disposed in a respective one of the recesses 124, 126, depending on whether the hand is a left or right hand. The hand will then be supported in a rounded orientation on the support surface 120, and should consistently be oriented in substantially the same position on the support surface, of course depending on whether the hand is a right or a left hand. Thus, the hand should be consistently in a predetermined position relative to the digital camera, the focus and size of a scanned image of the vein pattern of the hand should be consistent, and comparison of the image of the vein pattern of the backside of the palm with the image of the smart card, should be reliable.

In the preferred embodiment, a live hand is supported in a naturally rounded orientation on the support surface, but is not arched. Moreover, because the palm of the hand rests against the substantially flat surface portion 140 of the support surface, the backside of the palm can be oriented substantially parallel to the camera lens. This feature further facilitates obtaining a reliable and useful scanned image. In addition, by supporting the user's hand in a naturally rounded position, a user should feel comfortable in positioning the hand. The configuration of the support device 102 is designed to intuitively guide the placement of the user's hand. Feedback to the user while placing his hand can be visually displayed via the LCD. For example, pressure sensors along the side and front walls 132a, b, 134a, b of the posts and additional pressure sensor(s) on the substantially flat portion 140 of the support device 102, can provide output that can be used to determine if a hand is properly positioned on the support device, and provide output to aid a person in properly positioning his/her hand, via the LCD.

The digitized image on the “smart card” is obtained in the same manner as the comparison process—i.e. the user places his/her hand on a similar support device (or the same support device), and a reference image of the vein pattern of the person's hand is obtained via a digital camera. The image is digitized then written to the smart card's microchip. The digitized image on the “smart card” is then available when the person inserts the smart card in a sensing device, and has his/her hand scanned by the sensing system, and compared with the image on the smart card, to enable the sensing system either to confirm or reject the identify the person.

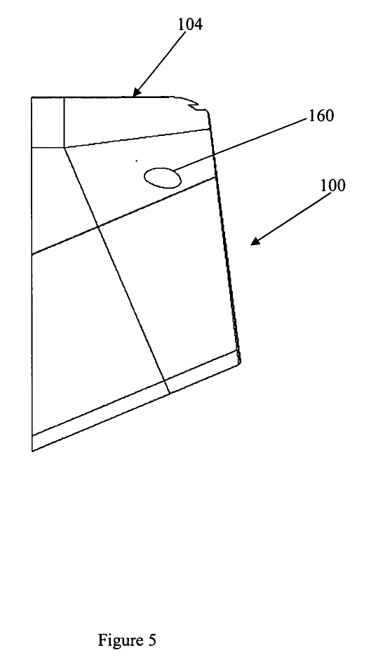

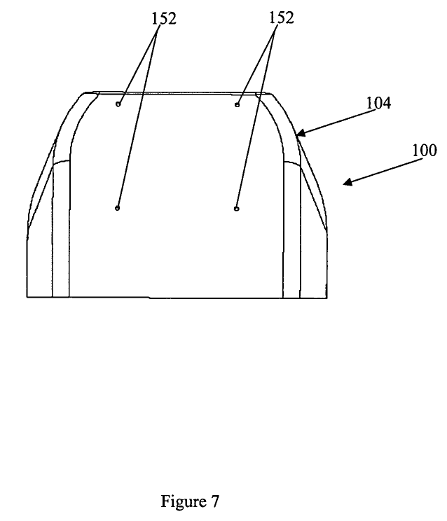

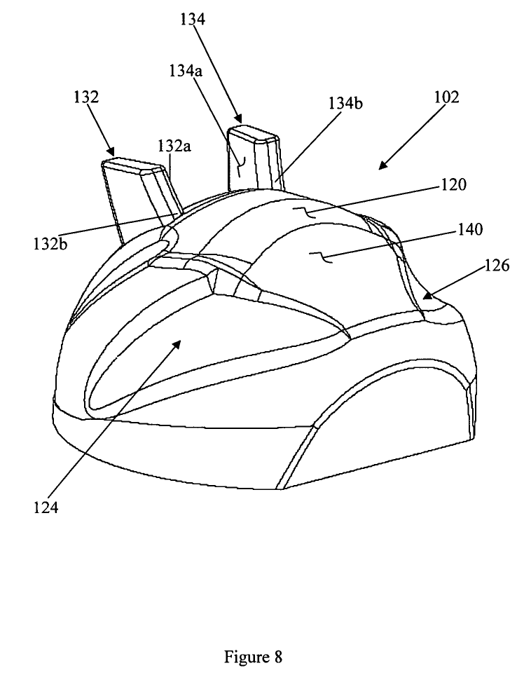

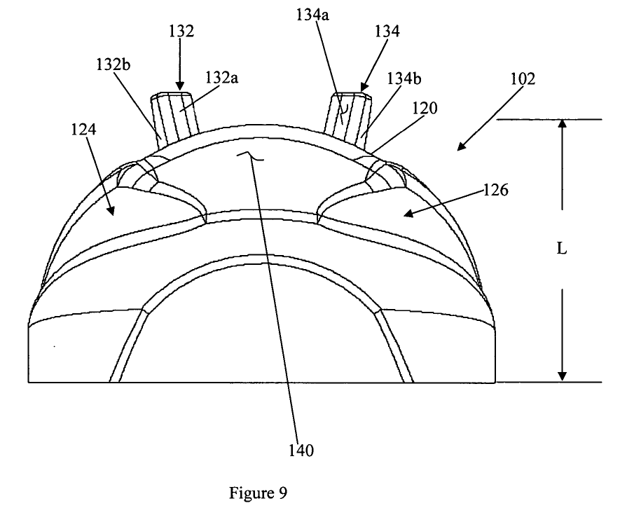

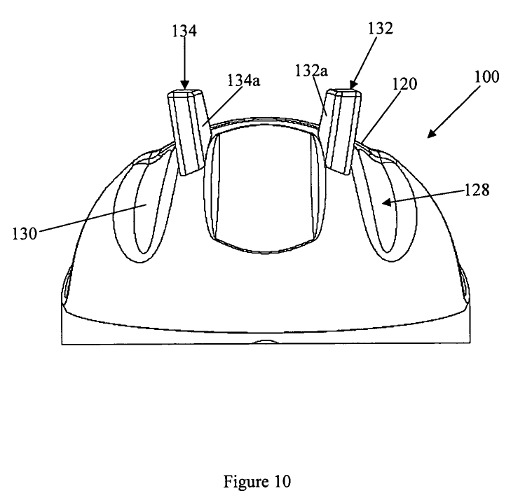

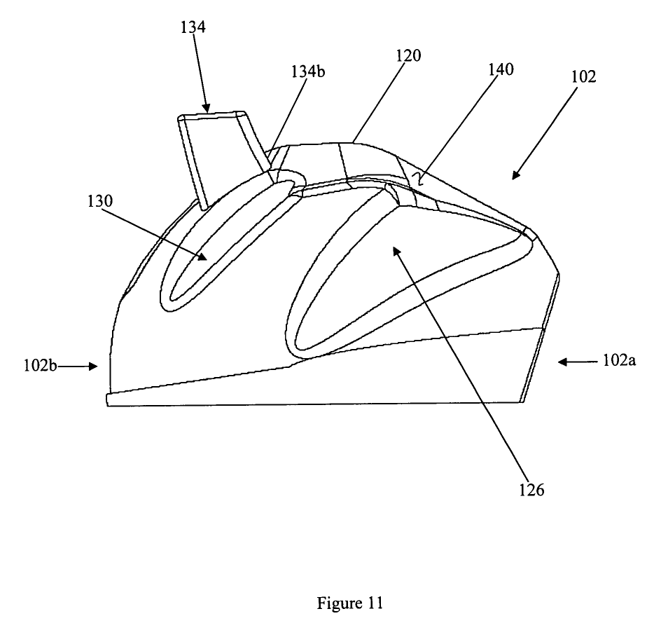

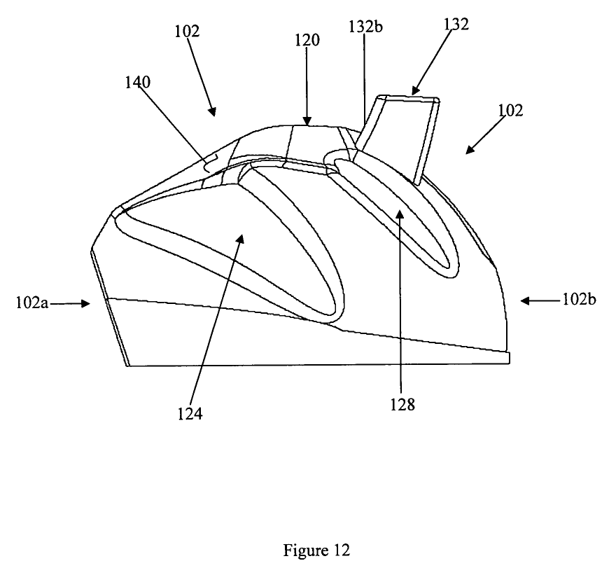

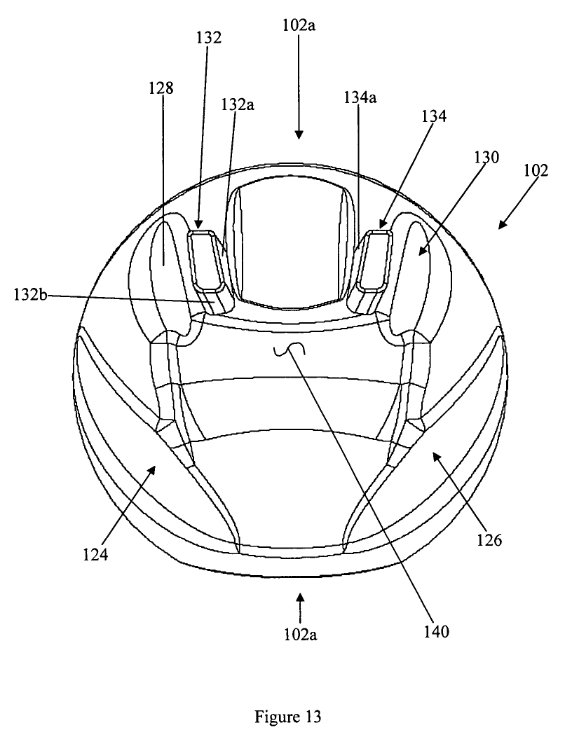

It is also believed useful to note that the support device 102 is preferably fixed to the bottom of the housing 104, by means of screws or other connectors that can extend through openings 150 in the support device 102 (see FIG. 14) and openings 152 in the housing 104 (see FIG. 7). However, the support device may be connected to the housing by other connecting means (e.g. adhesive). Also, the housing 104 can be secured to a wall or other support by means of screws or other connectors that extend through openings 160 in the housing 104 (see e.g. FIGS. 1 and 5). Moreover, the housing can be secured to a wall or other support by other connecting means. When the housing 104 is secured to a wall, the back side 108 of the housing would be against (adjacent to) the wall, and the front side 106 would be spaced from the wall, with the front opening 110 positioned to allow a person's hand to be conveniently inserted through the front opening and onto the support device 102.

Thus, the principles of the present invention are preferably used in connection with a hand support for a biometric identification system, but it is also contemplated that the principles of the present invention can also be employed in other types of operation environments. An “operating environment” is an environment in which some operation is performed relative to the hand, which the hand is supported on the support member. The preferred operating environment is in a scanning system in which the back of the hand is scanned and used in a biometric identification system. However, if there is a need in other operating environments, e.g. a surgical environment where comfortable and repeatable support and positioning for a patient's hand in a desirable position for an operating surgeon is important, the principles of the present invention should be applicable in such an environment. In such a (surgical) operating environment, where comfortable positioning of a human hand, in a desirable position for an operating surgeon, may be more important that repetitive positioning of a hand in a biometric scanning system, the principles of the present invention would provide a support member with a three dimensional rounded support surface configured to receive and support a human hand, with the hand in a rounded position and the back side of the palm in a predetermined position in the operating environment. The posts and/or recesses of the support surface, along with the substantially flat surface, would enable a human hand that is supported on the support surface to be comfortably positioned in a predetermined position in the operating environment.

Thus, from the foregoing description, it will be clear how the present invention can also be used to support a human hand in connection with various types of operating environments.

With the foregoing disclosure in mind, there will be other modifications and developments that will be apparent to those in the art.

What is claimed is:

1. An article for use in supporting a human hand in a scanning system, comprising
a. a support member with a three dimensional rounded support surface,
b. the support surface configured to receive and support a human hand, with the hand in a rounded position and the back side of the palm facing a predetermined portion of the scanning system, and
c. the support surface including at least one positioning component that is configured to enable a human hand to be positioned in a substantially similar position in relation to the scanning system each time the hand is supported on the support surface.

2. An article as defined in claim 1, wherein the positioning component comprises at least one recess in the support surface, the recess configured to receive a finger of a human hand when the hand is supported on the support surface.

3. An article as defined in claim 2, wherein the positioning component further comprises a plurality of recesses in the support surface, each recess configured to receive and support a predetermined finger of a human hand when the hand is supported on the support surface.

4. An article as defined in claim 3, wherein the plurality of recesses further includes recesses configured to receive predetermined fingers of a human hand, irrespective of whether the hand is a left or right hand that is supported on the support surface.

5. An article as defined in claim 4, wherein the positioning component comprises a substantially flat portion configured to provide a rest for the palm of a human hand, irrespective of whether the hand is a left or right hand that is supported on the support surface.

6. An article as defined in claim 5, wherein the positioning component further includes at least one post projecting outward from the support surface and located to be positioned between and adjacent a pair of fingers of a human hand when the hand is supported on the support surface.

7. An article as defined in claim 6, wherein the positioning component includes a plurality of posts projecting outward from the support surface, the plurality of posts located to be positioned between and adjacent selected fingers of a human hand, irrespective of whether the human hand is a right or a left hand.

8. An article as defined in claim 7, wherein the plurality of posts include a pair of spaced apart posts, and wherein the plurality of recesses are located outside the spaced apart posts and comprise recesses that are configured to receive the thumb and another finger of a human hand, irrespective of whether the human hand is a right or a left hand.

9. An article as defined in claim 8, wherein the height of the support surface is configured to enable the back of the palm of a hand resting on the support surface to be within the range of focus of an imaging device forming part of the scanning system.

10. An article as defined in claim 9, wherein the support surface is formed in one piece with the posts and the recesses.

11. An article as defined in claim 1, wherein the positioning component comprises a substantially flat portion configured to provide a rest for the palm of a human hand, irrespective of whether the hand is a left or right hand that is supported on the support surface.

12. An article as defined in claim 1, wherein the positioning component further includes at least one post projecting outward from the support surface and located to be positioned between and adjacent a pair of fingers of a human hand when the hand is supported on the support surface.

13. An article as defined in claim 12, wherein the positioning component includes a plurality of posts projecting outward from the support surface, the plurality of posts located to be positioned between and adjacent selected fingers of a human hand, irrespective of whether the human hand is a right or a left hand.

14. An article as defined in claim 13, wherein the plurality of posts include a pair of spaced apart posts, and wherein the plurality of recesses are located outside the spaced apart posts and comprise recesses that are configure to receive the thumb and another finger of a human hand, irrespective of whether the human hand is a right or a left hand.

15. An article as defined in claim 1, wherein the height of the support surface is configured to enable the back of the palm of a hand resting on the support surface to be within the range of focus of an imaging device forming part of the scanning system.

16. An article for use in supporting a human hand in an operating environment, comprising
a. a support member with a three dimensional rounded support surface,
b. the support surface configured to receive and support a human hand, with the hand in a rounded position and the back side of the palm in a predetermined position in the operating environment,
c. at least one post projecting outward from the support surface and located to be positioned between and adjacent a pair of fingers when the hand is supported on the support surface,
d. the support surface including a plurality of recesses, each configured to receive a finger of a human hand, and
e. the locations of the post and the recesses configured to enable a human hand that is supported on the support surface to be consistently positioned in a predetermined position in the operating environment.
